(19) United States
(12) Patent Application Publication
(10) Pub. No.: US 2023/0132533 A1
(43) Pub. Date: May 4, 2023

(54) ELECTROLESS PLATING OF CONDUCTIVE COMPOSITES

(71) Applicant: U.S. Army DEVCOM, Army Research Laboratory, Adelphi, MD (US)

(72) Inventors: Nathan S. Lazarus, Rockville, MD (US); Jorge A. Cardenas, Tucson, AZ (US); Harvey Hing-Cheong Tsang, Baltimore, MD (US)

(21) Appl. No.: 17/517,336

(22) Filed: Nov. 2, 2021

(51) Int. Cl. C23C 18/16; C23C 18/20; C23C 18/24; C23C 18/31

(52) U.S. Cl. CPC C23C 18/1641; C23C 18/1608; C23C 18/204; C23C 18/24; C23C 18/31

(57) ABSTRACT

A method and apparatus for electroless plating of a conductive composite created using fused filament fabrication. The method comprises fused filament fabricating a three-dimensional object with conductive filament and non-conductive filament. The object is then plated with electroless plating, with the metal in the conductive filament forming nucleation sites.

### GOVERNMENT INTEREST

The invention described herein may be manufactured, used and licensed by or for the U.S. Government.

### BACKGROUND

### Field

Embodiments of the present invention generally relate to electroless plating, and more particularly, to electroless plating of conductive composites.

### Description of the Related Art

Electroless plating, alternatively known as autocatalytic plating, is a widely used plating technique relying on a surface reaction with metal ions in a plating bath to deposit layers of metal on a surface without an applied voltage. Unlike electroplating, which relies on an externally applied electric field to drive the deposition process, electroless plating does not require any external fields or electrical connection to the region intended to be plated, and the process is reliant purely on the surface reactivity with the plating bath. This property makes electroless plating ideal for metallization in applications like circuit boards where there are numerous independent electrodes, as well as for depositing metals deep into trenches or valleys where electroplating is not practical.

As a surface reaction, the process is however highly surface dependent; while many metals can be easily plated using electroless plating, many other materials such as plastics cannot. Due to the desirable properties of metals in terms of strength, thermal and electrical conductivity and magnetic behavior, there are now widely used commercial process for electroless plating of plastics. Since plastics themselves are not easy to plate, it is necessary to perform a series of surface treatments prior to plating. The plastic surface is first sanded to clean the surface, etched in acid to create surface roughness, the acid is neutralized, the surface is activated with a noble metal catalyst, and finally electroless plating is performed. The noble metal catalyst is by far the most costly component of this process, and is a significant barrier to use in many applications.

The most common three-dimensional (3D) printing approach is fused filament fabrication (FFF), which is based on depositing droplets of melted thermoplastics to build 3D parts. Within 3D printing through fused filament fabrication, electroless plating based on noble metal catalyst deposition is most common with a single thermoplastic part where the entire surface is activated and plated, resulting in a continuous film. This approach is not selective, a major drawback to its use in 3D printed electronics. Another method for electroless plating is to deposit a layer of metal particles on the surface followed by plating. While the overall surface remains inert, the individual particles serve as nucleation sites, and after sufficient time the plated metal will merge into a continuous film.

Therefore, there is a need in the art to selectively perform electroless plating on plastic objects without using a noble metal catalyst.

### SUMMARY OF THE INVENTION

Embodiments of the invention include a method and apparatus for selective deposition of bulk metal layers on three dimensional objects comprising conductive composites. The method comprises creating a three-dimensional object using a conductive filament and a non-conductive filament in a fused filament fabrication process (i.e., creates a three-dimensional conductive composite) and then electroless plating the object.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a schematic diagram of apparatus for creating an object using fused filament fabrication with dual extrusion of a non-conductive filament and a conductive filament;

FIG. 2 depicts photographs of circuit boards produced using at least one embodiment of the present invention;

FIG. 3 depicts a flow diagram of a method of electroless plating an object in accordance with at least one embodiment of the invention;

FIG. 4A depicts a schematic diagram of an object having a non-conductive substrate with conductive particles on the surface in accordance with at least one embodiment of the invention;

FIG. 4B depicts a schematic diagram of the object of FIG. 4A having conductive material deposited using electroless plating in accordance with at least one embodiment of the invention;

FIG. 5 depicts a schematic view of a flash ablation apparatus in accordance with at least one embodiment of the present invention;

FIGS. 6A-D depict process steps for use of the flash ablation metallization apparatus to facilitate electroless plating upon a three-dimensional conductive composite;

FIG. 7 shows an example of a 3D geometry, an air core solenoid inductor, printed in copper loaded filament with (left) and without (right) electroless plating;

FIG. 8 shows a copper-loaded filament at different plating times in copper electroless plating solution showing stages of metallization;

FIG. 9 shows the same copper-loaded filament plated after flash ablation metallization was used to ablate the surrounding thermoplastic matrix and expose the metal particles; and

FIG. 10 is a plot showing the resistance of the copper loaded filament for different electroless plating times, with and without flash ablation performed.

### DETAILED DESCRIPTION

Embodiments of the present invention include a method of electroless plating of conductive composites created using a fused filament fabrication (FFF) technique (a form of 3D printing). FFF forms an object through deposition of repeated layers of melted thermoplastics. In one embodiment, an object is created using FFF with dual extrusion to selectively deposit a conductive filament and a non-conductive filament before the object is plated using electroless plating. By combining conductive and non-conductive filaments, an FFF composite is created. Selective placement of the conductive filament facilitates selectively located metallization on the object. After printing, conductive particles on the surface of the object form a catalytic surface that can be electroless plated. As such, the location of the conductive particles on the conductive filament controls the metallization location.

In an alternative embodiment, flash ablation may be used to expose additional conductive filament particles at the surface of the object to increase the density of conductive particles at the surface and improve the plating process. An exemplary flash ablation process is described in commonly assigned U.S. patent application Ser. No. 16/866,396, filed 4 May 2020, entitled “Photonic Annealing of Electrically-Conductive Thermoplastics,” (referred to herein as the '396 patent application) which is hereby incorporated herein by reference in its entirety. The '396 patent application describes photonic annealing to treat electrically-conductive thermoplastic. A source of light used for photonic annealing may be ultraviolet (UV), visible, and/or infrared (IR).

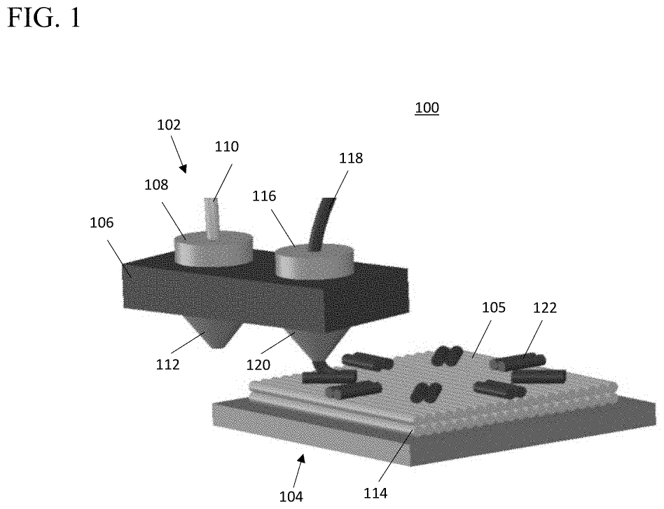

FIG. 1 depicts a schematic diagram of apparatus 100 that uses three-dimensional (3D) FFF printing to produce an object containing both conductive and non-conductive materials. The 3d object is selectively metallized using an electroless plating technique in accordance with an embodiment of the present invention. In one exemplary embodiment, the apparatus 100 comprises a FFF assembly 102 and a buildplate 104 upon which a 3D object 105 is printed. The FFF assembly 102 comprises a body 106, a first input 108 coupled to the body 106 that intakes a non-conductive material 110, a first extruder 112 coupled to the body 106 for extruding a non-conductive filament 114 as a portion of the object 105, a second input 116 coupled to the body 106 that intakes a conductive material 118, and a second extruder 120 coupled to the body 106 for extruding a conductive filament 122 as a portion of the object 105. Conductive filaments 122 and non-conductive filaments 114 are deposited on the build plate 104 to form a 3D object 105. In this embodiment, the FFF assembly is a dual extruder, wherein both the first extruder 112 and the second extruder 120 are coupled to the same body 106 of an FFF assembly 102. For example, the FFF apparatus may be a MakerBot Replicator 2×. In other embodiments, the extruders may be separated, i.e., not coupled to the same body 106.

The material that forms the conductive filament 122 comprises metal particles mixed into a thermoplastic matrix. These metal particles can serve as nucleation sites for metal deposition when the surface particles are exposed to a electroless plating solution. The metal particles may include, but are not limited to, one or more of copper, carbon black, nickel, iron, bronze, brass, gallium, bismuth, aluminum, Inconel, tungsten, stainless steel, titanium or graphene. If the particles are present in a high density, a continuous conductive film can be deposited, suitable for use as electrical traces. These electrical traces may be used to connect an integrated circuit mounted to the 3D object. In some embodiments, the conductive filament is based on copper particles within a biodegradable polyester, such as in Electrifi® available from Multi3D LLC. In such embodiments, the conductive filament is extruded at a temperature of about 130° C. In other embodiments, the conductive filament is based on carbon black filler particles in polyactic acid (PLA), for example, Protopasta Conductive PLA. In such embodiments, the conductive filament is extruded at a temperature of about 200° C. In some embodiments, the non-conductive material is Acrylonitrile Butadiene Styrene (ABS), for example, Makerbot True Green ABS. The non-conductive filament may be extruded at a temperature of of between 150° C. and 250° C. In one embodiment, the conductive and non-conductive filaments are deposited in layers having a thickness of about 0.1 mm.

After the object is printed, the object is placed in an electroless plating solution such as Transene PC Electroless Copper or other solutions suitable for metal plating such as, but not limited to, one or more of silver, aluminum, nickel, solder or iron solutions. The solution is heated to about 40° C. The solution is agitated to prevent localized depletion of the reactants in the solution. The 3D object is submerged in the solution for a period of time, e.g., two to four hours, and, when plating is complete, the object is rinsed and dried. Note that there is no need for activation of the metal particles. Wherever conductive particles are exposed on the surface of the object, nucleation will occur and metal is deposited. With continuous exposure to the plating solution, metallization will occur between surface particles until a continuous metal surface is deposited. No plating occurs in regions where conductive particles are not exposed on the surface of the object. As such, selective metallization is achieved. In this manner, conductive circuit traces may be formed via FFF.

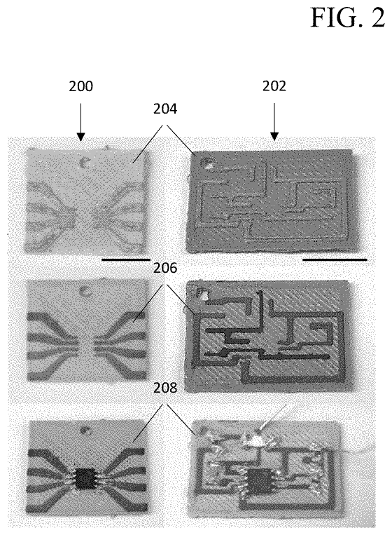

FIG. 2 depicts a photograph of two different 3D objects, i.e., circuit boards 200 and 202, created as described above. The circuit boards 200/202 at 204 show traces formed of conductive filament material atop a substrate formed from non-conductive filament material. At 206, the conductive filament traces have been electroless plated such that selective metallization has formed conductive traces. At 208, electronic components have been soldered to the traces of the FFF generated circuit board. The plating process significantly improves the conductivity of the printed traces. For example, a trace formed from Conductive PLA has a resistance of 11.5 kΩ prior to plating and a resistance of 96 mΩ after plating. A trace formed from Electrifi material had a resistance of 38.7 Ω before plating and 1.9 Ω after plating.

In another embodiment, a toroidal inductor was FFF created using Protopasta Conductive PLA on an ABS substrate. The inductor had an outer diameter of 40 mm, an inner diameter of 20 mm and a height of 12 mm with 16 turns. The as printed inductor had a resistance of 24 kΩ and, after plating, had a resistance of 2.3 Ω. The inductor had a measured inductance of about 320 nH and a peak quality factor of 10.7 over a 100 kHz to 10 MHz frequency range. The theoretical inductance of such an inductor had an analytical value of 355 nH.

In some embodiments, the 3D object 105 in FIG. 1 is subject to a Flash Ablation Metallization (FAM) process in order to increase the density of metal sites on the surface of the object and accelerate the plating process. Conductive particles can absorb light differently than polymers, which may be used for selective heating. A pulse of intense white light may be used on a conductive filament containing particles to ablate a thin layer of the thermoplastic matrix and leave behind a higher density of metal particles on the surface layer. The FAM process is described in detail in the '396 patent application. By ablating the thermoplastic matrix to increase the density of exposed particles, the plating process is accelerated and improves the electrical characteristics of the metallized areas. In some embodiments, a 20 ms pulse at 450 V bank voltage is applied to a lamp to produce about 25 J/cm² energy density is sufficient to ablate the conductive filament material.

In one exemplary embodiment, a conductive trace formed from Electrifi material was ablated and had resistance of 7.5 Ω before plating. After plating, the trace had a resistance of 0.31 Ω. Note that, as mentioned above, after plating without ablation, the trace had a resistance of 1.9 Ω. In addition to improved electrical characteristics, ablation also accelerated the plating process. For example, a uniform, continuous metallized surface was formed on Electrifi material without ablation in four hours. With an ablated surface, a uniform, continuous metallized surface was formed in two hours—a factor of two improvement.

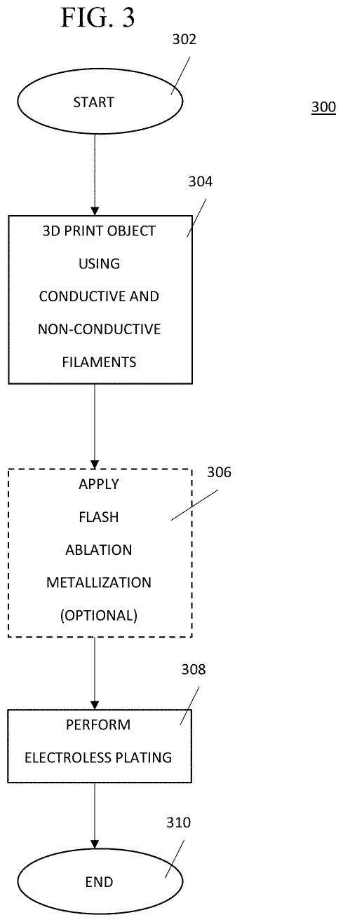

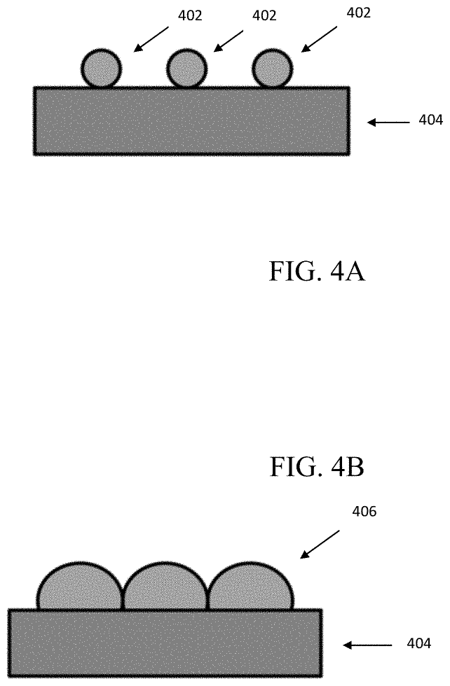

FIG. 3 is a flow diagram of a method 300 of producing a 3D object with metallization in accordance with at least one embodiment of the invention. The method 300 begins at 302 and proceeds to 304 where a 3D object is printed using conductive and non-conductive filaments. The location of the conductive filaments defines where the object is to be metallized. FIG. 4A is a schematic depiction of a non-conductive substrate 404 having conductive particles 402 at the surface. These particles 402 form nucleation sites.

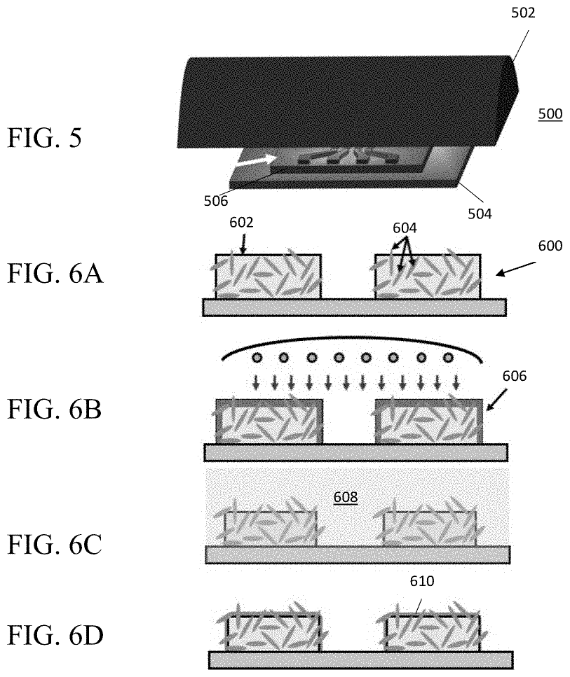

At 306, an optional flash ablation metallization (FAM) may be performed to increase the density of surface conductive particles, i.e., remove thermoplastic matrix and expose more conductive particles to the surface. More detail is provided regarding a FAM process with regard to FIGS. 5 and 6A-D below. At 308, the 3D object is electroless plated by immersing the object in electroless plating solution. The plating solution uses the conductive particles as nucleation sites and deposits additional metal at each site. Over time, the space between the particles fills in until a uniform, continuous layer of metal is formed. FIG. 4B is a schematic depiction of the space between surface particles of FIG. 4A being filled in to form a continuous layer 406.

The method 300 ends at 310.

FIG. 5 depicts a schematic view of a flash ablation apparatus 500 in accordance with at least one embodiment of the present invention. The apparatus 500 comprises a lamp assembly 502 positioned proximate a support 504 holding a circuit board 506 created using the FFF techniques described above.

FIGS. 6A-D depict process steps of a flash ablation metallization process. A cross-section of a portion of circuit board 506 appears at 600 in FIG. 6A where the polymer surface 602 has few metal particles 604 at the surface. In FIG. 6B, the ablation lamp is activated to remove polymer 602 from the surface and expose additional metal particles. At FIG. 6C, the circuit board is immersed in electroless solution 608. At FIG. 6D, the metal plating layer 610 from the solution 608 has been deposited between particles to form a continuous metallization layer.

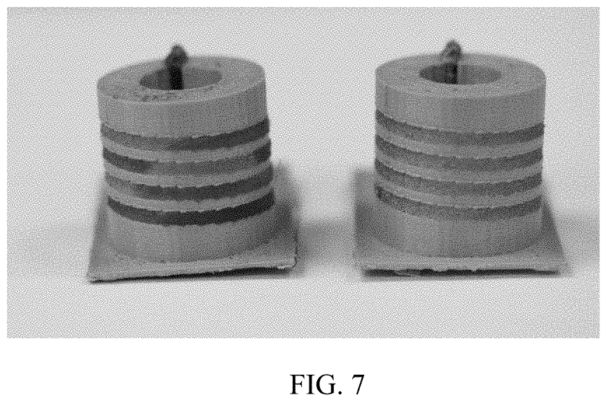

FIG. 7 shows an example of a 3D geometry, i.e., an air core solenoid inductor, printed in copper loaded filament with (left) and without (right) electroless plating for 8 hours in electroless plating solution. It was performed with Transene PC Electroless copper plating solution at 40° C. In particular, the images in FIG. 7 depict an air core solenoid inductor having an outer diameter of 21 mm was designed and formed in accordance with the various embodiments. The image of the left shows the 3D printed solenoid inductor above being subjected to 8 hours of electroless copper plating. It has a 28 Ω resistance. The image on the right shows the inductor with no plating. It has a 1.04 kΩ resistance. This demonstrates a ˜2 orders of magnitude reduction in resistance after electoless plating due to the addition of bulk copper on the surface.

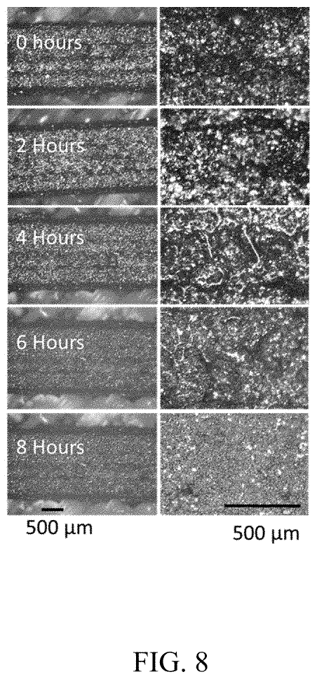

FIG. 8 shows a copper-loaded filament at different plating times in copper electroless plating solution showing stages of metallization. The electroless plating here was performed with same Transene PC Electroless copper plating solution at the same temperature of 40° C. With the electroless plating, a small amount of plating is observed initially, followed by nucleation at about 4 hours and finally a continuous film at 8 hrs.

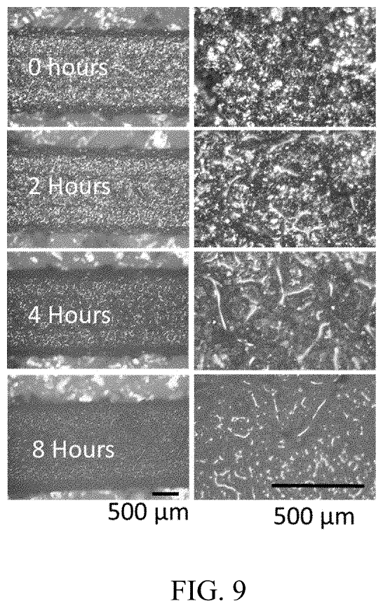

FIG. 9 shows the same copper-loaded filament plated after flash ablation metallization was used to ablate the surrounding thermoplastic matrix and expose the metal particles. The flash ablation was done with a 20 ms pulse at 450 V bank voltage corresponding to 25 J/cm² in a Novacentrix Pulseforge 1200 Intense Pulsed Light (IPL) system. The flash ablation metallization technique results in an accelerated plating process, with nucleation starting to be observed at ˜2 hours and continuous metal by 4-6 hours.

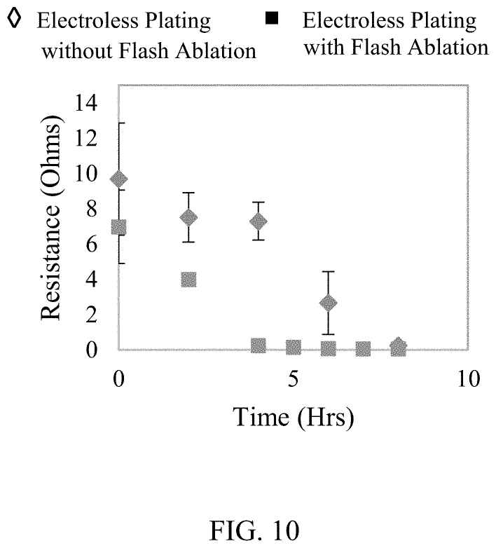

FIG. 10 is a plot showing the resistance of the copper loaded filament for different electroless plating times, with and without flash ablation performed. The same electroless plating and ablation techniques were used as were previously described for FIGS. 8 and 9, respectively. This further demonstrates that resistance is reduced at a much greater level with flash ablation than without it.

Where “coupling” or “connection” is used, unless otherwise specified, no limitation is implied that the coupling or connection be restricted to a physical coupling or connection and, instead, should be read to include communicative couplings.

Where conditional language is used, including, but not limited to, “can,” “could,” “may” or “might,” it should be understood that the associated features or elements are not required. As such, where conditional language is used, the elements and/or features should be understood as being optionally present in at least some examples, and not necessarily conditioned upon anything, unless otherwise specified.

While the foregoing is directed to embodiments of the present invention, other and further embodiments of the invention may be devised without departing from the basic scope thereof, and the scope thereof is determined by the claims that follow.

1. A method for electroless plating conductive composite formed using fused filament fabrication comprising:
fused filament fabricating a conductive composite using a conductive filament consisting essentially of a thermoplastic matrix and conductive metallic particles incorporated therein and a non-conductive filament, where the conductive filament defines a metallization location; and
electroless plating the conductive composite to deposit conductive material at the metallization location.

2. The method of claim 1, further comprising:
performing flash ablation metallization prior to electroless plating.

3. The method of claim 1, wherein the conductive filament consists of a thermoplastic matrix and conductive metallic particles incorporated therein.

4. The method of claim 1, wherein the conductive metallic particles are selected from the group consisting of copper, nickel, iron, bronze, brass, gallium, bismuth, aluminum, tungsten, stainless steel, and titanium.

5. The method of claim 1, wherein the non-conductive filament is extruded at a temperature between about 150° C. and about 250° C.

6. The method of claim 1, wherein the conductive filament is extruded at a temperature of about 130° C. to about 200° C.

7. The method of claim 1, wherein electroless plating is performed using one or more of a copper, silver, aluminum, nickel, solder or iron electroless plating solution.

8. The method of claim 1, further comprising selectively applying the conductive filament to define a location for a plurality of electrical traces of a printed circuit board.

9. An apparatus for electroless plating of a conductive composite formed using fused filament fabrication comprising:
a fused filament fabrication apparatus for fabricating a conductive composite using a conductive filament consisting essentially of a thermoplastic matrix and conductive metallic particles incorporated therein and a non-conductive filament, where the conductive filament defines a metallization location; and
an electroless plating bath for electroless plating the conductive composite to deposit conductive material at the metallization location.

10. The apparatus of claim 9, further comprising:
a flash ablating lamp for performing flash ablation metallization prior to electroless plating.

11. The apparatus of claim 9, wherein the conductive filament consists of a thermoplastic matrix and conductive metallic particles incorporated therein.

12. The apparatus of claim 9, wherein the conductive metallic particles are selected from the group consisting of copper, nickel, iron, bronze, brass, gallium, bismuth, aluminum, tungsten, stainless steel, and titanium.

13. The apparatus of claim 9, wherein the fused filament fabrication apparatus is configured to extrude the non-conductive filament at a temperature between about 150° C. and about 250° C.

14. The apparatus of claim 9, wherein the fused filament fabrication apparatus is configured to extrude the conductive filament at a temperature between about 130° C. to about 200° C.

15. The apparatus of claim 9, wherein electroless plating is performed using one or more of a copper, silver, aluminum, nickel, or iron electroless plating solution.

16. (canceled)

17. An apparatus for electroless plating of 3D printed conductive composite comprising:
a 3D printer for 3D printing a conductive composite using a conductive filament and a non-conductive filament, where the conductive filament consists essentially of a thermoplastic matrix and conductive metallic particles incorporated therein and the printing thereof defines a metallization location;
a flash ablating lamp for performing flash ablation metallization prior to electroless plating; and
an electroless plating bath for electroless plating the conductive composite to deposit conductive material at the metallization location.

18. The apparatus of claim 17, wherein the conductive metallic particles are selected from the group consisting of copper, nickel, iron, bronze, brass, gallium, bismuth, aluminum, Inconel, tungsten, stainless steel, or titanium.

19. The apparatus of claim 17, wherein electroless plating is performed using one or more of a copper, silver, aluminum, nickel, or iron electroless plating solution.

20. The apparatus of claim 17, wherein the 3D printer selectively applies the conductive filament to define a location for a plurality of electrical traces of a printed circuit board.

21. The apparatus of claim 17, wherein the conductive filament consists of a thermoplastic matrix and conductive metallic particles dispersed therein before being applied by the 3D printer.
